(19) United States
(12) Patent Application Publication
(10) Pub. No.: US 2012/0187123 A1
(43) Pub. Date: Jul. 26, 2012

(54) Apparatus and Methods for Closing a Vessel

(76) Inventors: Khalil Rabiei, Edwardsville, IL (US); Ali Sepehri, Edwardsville, IL (US); Kia Charib, Collinsville, IL (US); Michael Mettler, Florissant, MO (US)

(21) Appl. No.: 13/438,119

(22) Filed: Apr. 3, 2012

(51) Int. Cl. B65D 53/06; B65D 45/00; B65D 53/00; B23P 11/00

(52) U.S. Cl. 220/240; 29/525.08; 29/407.01; 220/315; 220/378

(57) ABSTRACT

A method of closing a vessel includes using a flexible sealing device to form a seal between two container components of the vessel. The method also includes closing the vessel by locking together the two container components using a locking mechanism capable of bearing an end pressure load against the vessel when the vessel is in operation. The seal is formed and the vessel is closed so that the sealing device bears substantially none of the end pressure load when the vessel is in operation. This method can be adapted to work in relation to many vessel designs and both high and low pressure and temperature conditions.

### FIELD

The present disclosure relates to apparatus and methods for closing a vessel.

### BACKGROUND

This section provides background information related to the present disclosure which is not necessarily prior art.

The pressure vessel industry covers a broad range of applications, including but not limited to autoclaves, storage tanks, heat exchangers, pressure vessels, and many other types of equipment used, e.g., in the petrochemical field. Whereas some types of equipment are operated continuously at steady state for long periods of time, some other types are used in batch processes (such as in the polycrystalline silicon industry) and are operated mostly in transient process conditions.

### SUMMARY

This section provides a general summary of the disclosure, and is not a comprehensive disclosure of its full scope or all of its features.

The present disclosure, in one aspect, is directed to a method of closing a vessel. The method includes using a flexible sealing device to form a seal between two container components of the vessel. The method also includes locking together the two container components using a locking mechanism capable of bearing an end pressure load against the vessel when the vessel is in operation. The method is performed so that the sealing device bears substantially none of the end pressure load when the vessel is in operation.

In another example embodiment, the disclosure is directed to a closure for closing a vessel. The vessel has first and second container components. The closure includes a flexible sealing device for attachment to one of the first and second container components such that the sealing device covers an edge of the other of the first and second container components inside the vessel when the vessel is closed. A locking mechanism is configured to secure the first container component to the second container component when the first container component is closed over the second container component. The locking mechanism, but substantially not the sealing device, is configured to bear a pressure end load against the vessel when the vessel is in use.

In another implementation, the disclosure is directed to a sealing device for use in sealing a vessel. A flexible, substantially closed-loop channel is configured to be sealed against a first container component of the vessel when the vessel is closed. The channel is configured to provide a jacket for fluid when the sealing device is attached to a second container component of the vessel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of a vessel in accordance with one implementation of the disclosure;

FIG. 2A is a top perspective view of a sealing device in accordance with one implementation of the disclosure;

FIG. 2B is a bottom plan view of a sealing device in accordance with one implementation of the disclosure;

FIG. 2C is a side cross-sectional view of a sealing device in accordance with one implementation of the disclosure;

FIG. 2D is a side cross-sectional view of a sealing device in accordance with one implementation of the disclosure, the view taken at a location of a baffle;

FIG. 3A is an exploded perspective view of an alignment wedge in accordance with one implementation of the disclosure;

FIG. 3B is a perspective view of an alignment wedge in accordance with one implementation of the disclosure;

FIGS. 4A and 4B are partial sectional views of a vessel and closure in accordance with one implementation of the disclosure;

FIG. 5A is a perspective view of a seating wedge in accordance with one implementation of the disclosure;

FIG. 5B is an exploded perspective view of a seating wedge in accordance with one implementation of the disclosure;

FIG. 6 is a perspective view of a guide slot and wedge insert for a seating wedge in accordance with one implementation of the disclosure;

FIG. 7A is a perspective view of a wedge insert in accordance with one implementation of the disclosure;

FIG. 7B is a side view of a wedge insert in accordance with one implementation of the disclosure;

FIG. 7C is a bottom view of a wedge insert in accordance with one implementation of the disclosure;

FIG. 7D is a top view of a wedge insert in accordance with one implementation of the disclosure;

FIG. 8 is a partial sectional view of a vessel and closure in accordance with one implementation of the disclosure;

FIG. 9 is a partial sectional view of a vessel and closure in accordance with one implementation of the disclosure;

FIG. 10A is a perspective view of a locking assembly in accordance with one implementation of the disclosure;

FIG. 10B is an exploded perspective view of a locking assembly in accordance with one implementation of the disclosure;

FIGS. 11A-11C are views of a support for a locking rod in accordance with one implementation of the disclosure;

FIG. 12 is a perspective view of a connecting link in accordance with one implementation of the disclosure;

FIGS. 13A-13B are perspective views of an alignment rod in accordance with one implementation of the disclosure;

FIG. 14 is a top view of a vessel and closure in accordance with one implementation of the disclosure;

FIG. 15 is a partial sectional view of a vessel and closure in accordance with one implementation of the disclosure; and

FIG. 16 is a partial sectional view of a vessel and closure in accordance with one implementation of the disclosure.

Corresponding reference numerals indicate corresponding parts throughout the several views of the drawings.

### DETAILED DESCRIPTION

Example embodiments will now be described more fully with reference to the accompanying drawings.

The inventors have observed that in a batch process in which a pressure vessel is used, the duration of turnarounds between operating cycles can have a significant effect on the overall production of the process. The inventors also have observed that the time it takes to close and open a vessel can be a major factor in the duration of a turnaround. Having to tighten and loosen bolts, for example, can increase turnaround time. In various implementations of the disclosure, a closure is provided that does not require the use of bolts to seal or open a vessel.

In various aspects of the disclosure, a method of closing a vessel also is provided in which a flexible sealing device is used to form a seal between two container components of a vessel. The vessel is closed by locking together the two container components using a locking mechanism capable of bearing an end pressure load against the vessel when the vessel is in operation. The seal is formed and the vessel is closed so that the sealing device bears substantially none of the end pressure load when the vessel is in operation. Various embodiments of the method can be used in relation to many vessel designs and both high and low pressure and temperature.

In one configuration, a closure is provided for closing a vessel where the vessel includes two container components. A flexible sealing device may be attached to one of the container components such that the sealing device covers an edge of the other container component inside the vessel when the vessel is closed. A locking mechanism may be attached to an outer side of one container component and/or to a surrounding support structure, to secure that container component to the other container component when the vessel is closed. It should be noted that the locking mechanism is configured independently of the sealing device to bear a pressure load against the vessel when the vessel is in use.

In some configurations, a sealing device includes a flexible, substantially closed-loop channel configured to be sealed against one of two container components of a vessel when the vessel is closed. The channel provides a jacket for fluid when two edges of the channel are attached to the other container component of the vessel. The fluid may be controlled, e.g., to vary temperature and/or pressure of the sealing device.

In one configuration of a locking mechanism, one or more locking assemblies may be attached to an outer side of a first container component. Each locking assembly has a plurality of locking pins for insertion through holes in the first container component into bores of the second container component to close the vessel when the first container component is positioned over the second container component.

In various configurations a mechanism for seating a gasket against a sealing device has a plurality of actuators that correspond to slots of one of two vessel container components. Each actuator is operable to move a projection member configured to fit into a corresponding slot. When the actuators are positioned around the vessel, the actuators are operable to force the projection members into the corresponding slots to cause the gasket to be seated against a sealing device attached inside the vessel to one of the container components.

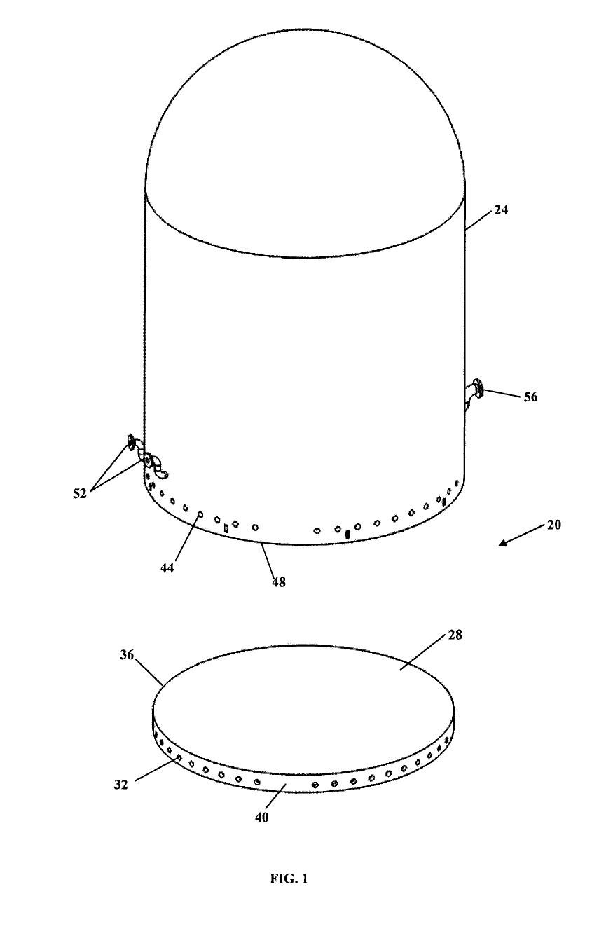

An example vessel in accordance with one implementation of the disclosure is indicated generally in FIG. 1 by reference number 20. The vessel 20 is a bell jar-type vessel. It should be understood, however, that other or additional types and/or shapes of vessels could be provided with closures in accordance with aspects of the present disclosure. In the present example the vessel 20 has two container components, e.g., a shell 24 and a base plate 28. The base plate 28 has a plurality of holes 32 spaced along an edge 36 of the base plate 28.

A plurality of holes 44 extend through an edge 48 of the shell 24 and correspond to the holes 32 in the base plate. A pair of fluid inlets 52 and a fluid outlet 56 extending through the shell 24 may be used to control temperature and/or pressure in a sealing device as further described below. It should be noted that the number and spacing of holes 32 and 44, and number and locations of inlets 52 and outlets 56, are examples only. Other numbers, spacing arrangements, and/or locations could be provided for various vessels.

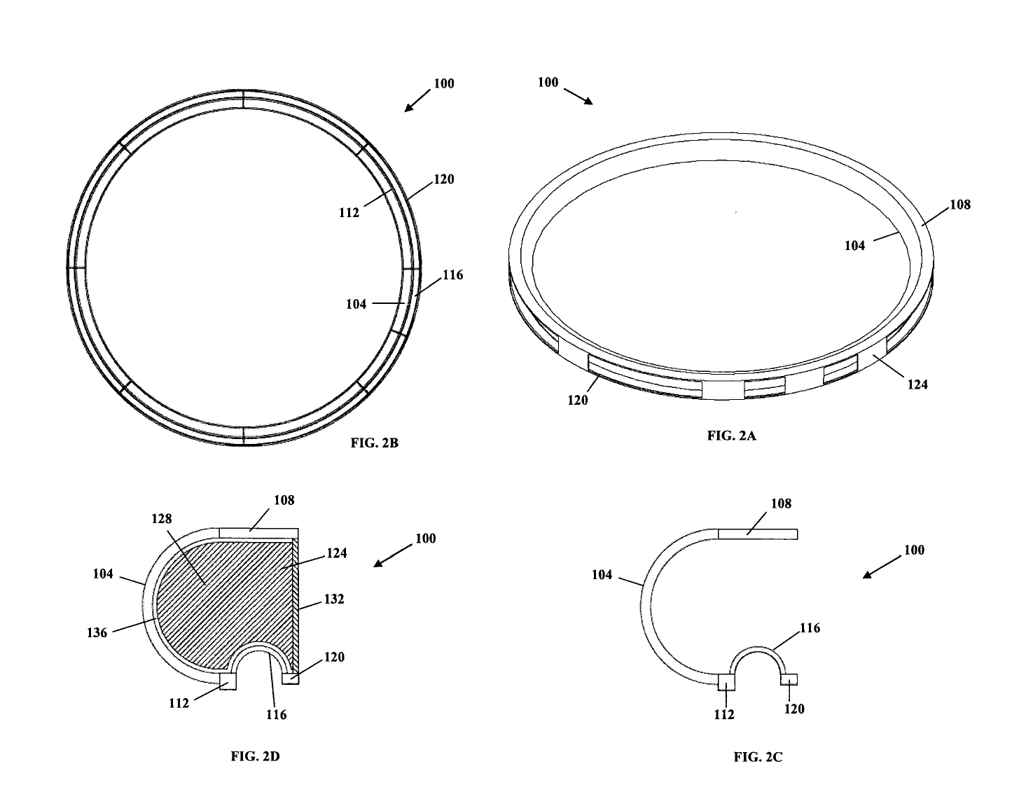

A closure for the vessel 20 includes a flexible sealing device indicated generally in FIGS. 2A-2D by reference number 100. The sealing device 100 is configured for attachment to an inner side of the shell 24 and to have a circulating fluid. When attached inside the shell 24, the sealing device 100 extends as a closed loop around the inner perimeter of the shell 24. The sealing device 100 is sealed against the base plate 28 when the vessel 20 has been closed.

The sealing device 100 includes a half-pipe 104 connected with a top portion 108 rigidly attached to the shell 24. The half-pipe 104 is also connected with a sealing tongue 112 that becomes seated on a base plate gasket when the vessel is closed as further described below. A half-pipe 116 is connected between the sealing tongue 112 and a bottom portion 120 rigidly attached to the shell 24. It should be noted that the half-pipes and other elements of the sealing device 100 are exemplary only. Other elements and/or configurations are possible that provide the same or similar features.

The “closed-loop” design of the sealing device 100 allows temperature and/or pressure of the sealing device 100 to be controlled by means of a jacket fluid. Pressure and/or temperature inside the sealing device 100 may also be used to optimize contact pressure and contact width of the sealing device 100 between the shell 24 and the base plate 28. Pressure and temperature can be adjusted during operation of the vessel. Adjustments can be made in various ways. For example, adjustments may be predetermined based on analysis using operating conditions. Additionally or alternatively, adjustments may be made actively by using feedback from appropriate instrumentation.

It should be understood generally that sealing devices could have various types, sizes, profiles, shapes, and/or locations in various vessel configurations in accordance with aspects of the present disclosure. For example, a sealing device could be configured for attachment to a base plate of a vessel and could be sealed, e.g., against a ledge in a shell of the vessel when the vessel is closed.

The flow of the jacket fluid may be controlled by a plurality of baffles 124, one of which is shown in FIG. 2D. The baffles 124 are configured so as to add little or no local stiffness to the sealing device 100 in order to maintain the flexibility of the sealing device 100. A baffle 124 includes one or more baffle plates 128, each baffle plate 128 having a plurality of holes (not shown) through which the jacket fluid may travel. An end plate 132 of a baffle 124 is attached, e.g., welded, to the baffle plate(s) 128 and also is attached, e.g., welded, to the top portion 108 and bottom portion 120 of the sealing device 100. An end plate 132 thus rigidly connects the baffle plate(s) 128 with the sealing device 100. Baffle plates 128 are otherwise unattached, e.g., separated from the half-pipes (104, 116) and sealing device top and bottom portions (108, 120) by a small gap 136. Sealing device and/or baffle components may be fabricated, e.g., of solid Inconel®. Combinations of carbon steel and Inconel® could also be used. Other or additional materials may also be suitable in various implementations. It should be noted that the numbers, sizes and locations of baffles, baffle plates, and/or holes in baffle plates, attachments of baffle plates in relation to baffles, and/or attachments of baffles in relation to a sealing device may vary dependent on various specific configurations of vessels and/or sealing devices.

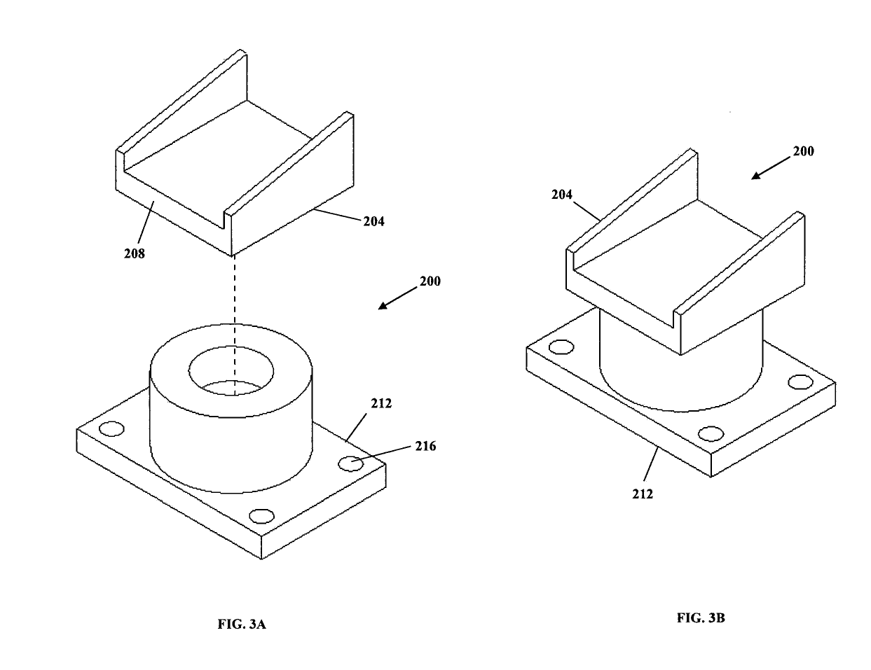

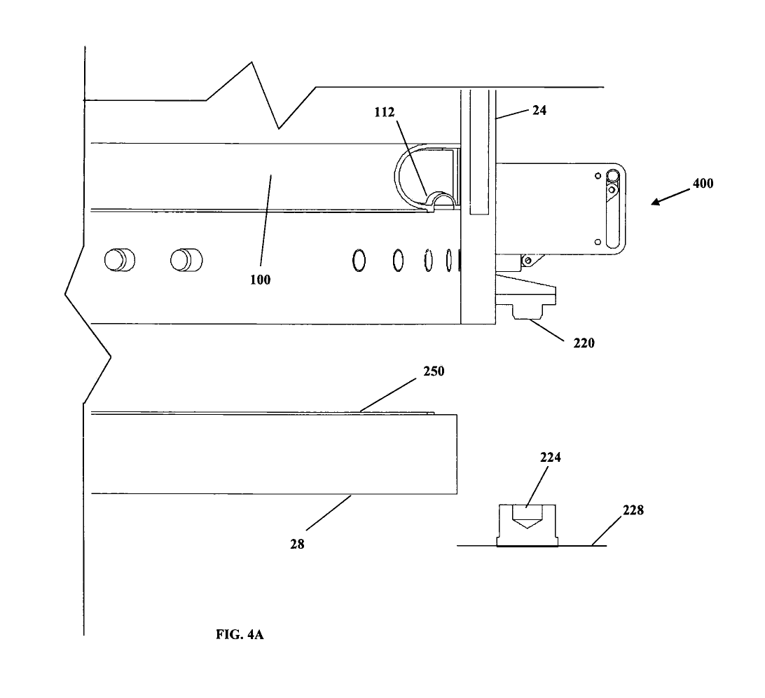

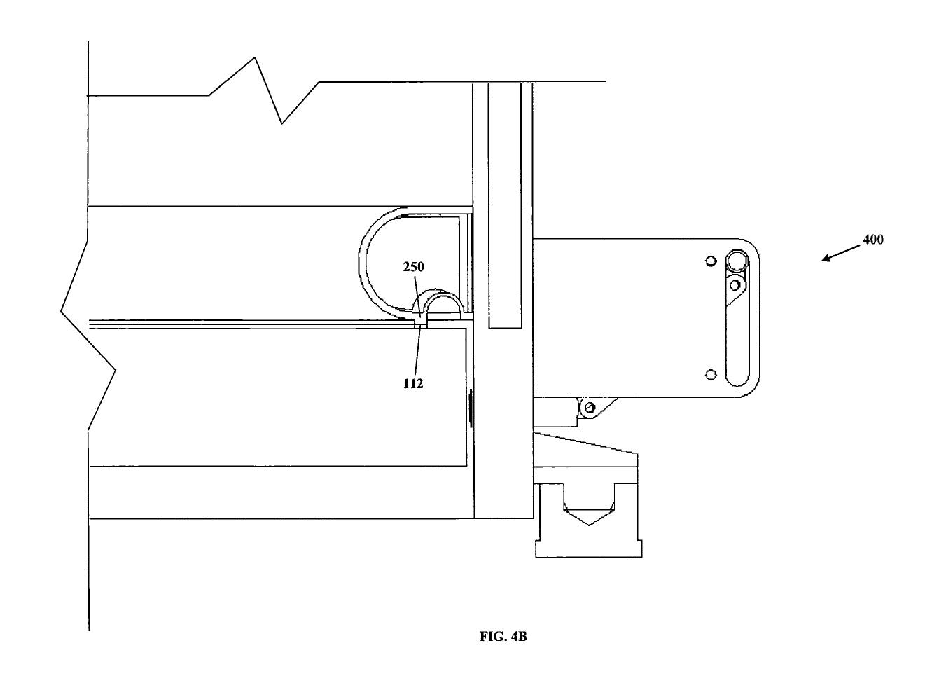

A plurality of alignment mechanisms may provide fine alignment of the shell 24 with the base plate 28. One example alignment mechanism includes an alignment wedge indicated generally in FIGS. 3A-3B by reference number 200. The alignment wedge 200 has a wedge portion 204 attached to the shell 24 along a side 208 of the wedge portion 204. A base 212 of the alignment wedge 200 is attached, e.g., bolted through bolt holes 216, to a supporting structure for the vessel 20.

The vessel 20 is partially shown in FIGS. 4A and 4B, which are sectional views taken through an alignment wedge 200. In FIG. 4A the shell 24 is in an elevated position over the base plate 28. The wedge portion 204 has a generally cylindrical protrusion 220 that allows rotation of the wedge portion 204 in a cylindrical bore 224 of the base 212 when the wedge portion 204 and base 212 are engaged. As the shell 24 reaches its lowered position, the alignment wedge portions 204 attached to the shell 24 become engaged with their corresponding bases 212 attached to support structure 228. In FIG. 4B the shell 24 is in a lowered position over the base plate 28, and the wedge portion 204 and base 212 of the alignment wedge 200 are engaged. Partially shown in FIGS. 4A and 4B is a locking assembly, referred to generally by reference number 400 and further described below.

It should be noted that the alignment wedges 200 are exemplary only. Various types of alignment mechanisms could be used. As one example, an element attached to surrounding support structure could be rotatable in an element attached to a shell. Additionally or alternatively, alignment mechanisms could have various shapes, sizes, attachment features, and/or relationships with various types of vessels in order to provide functionality as described herein.

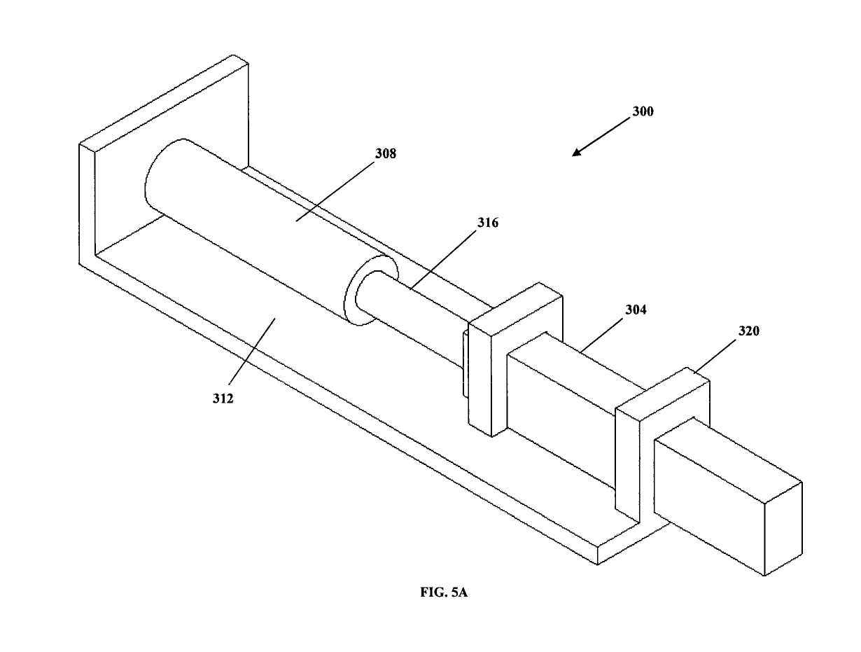

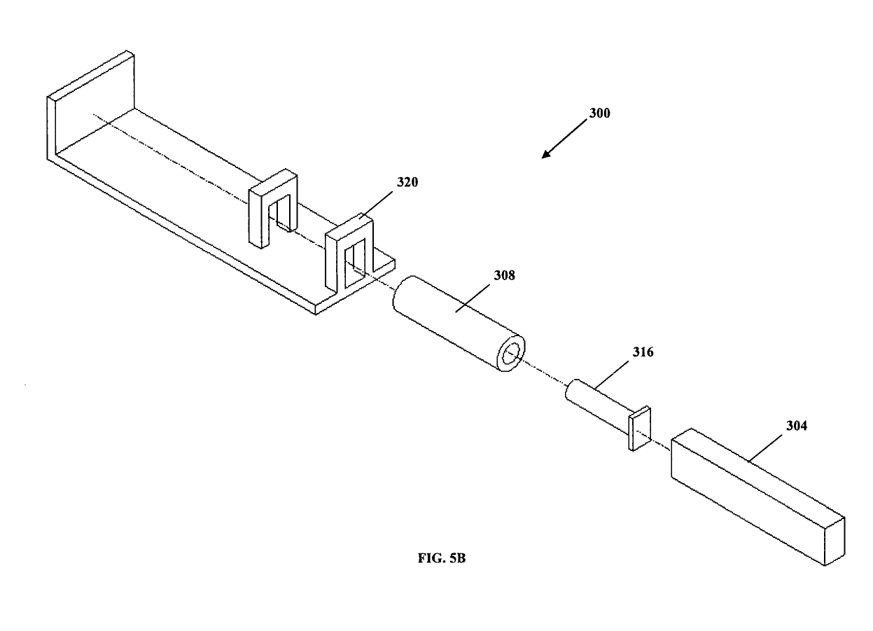

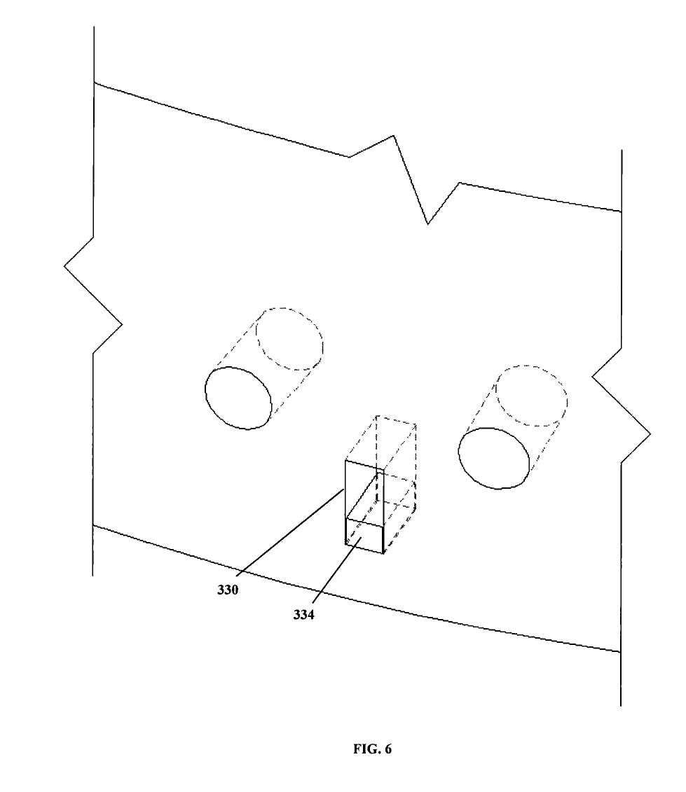

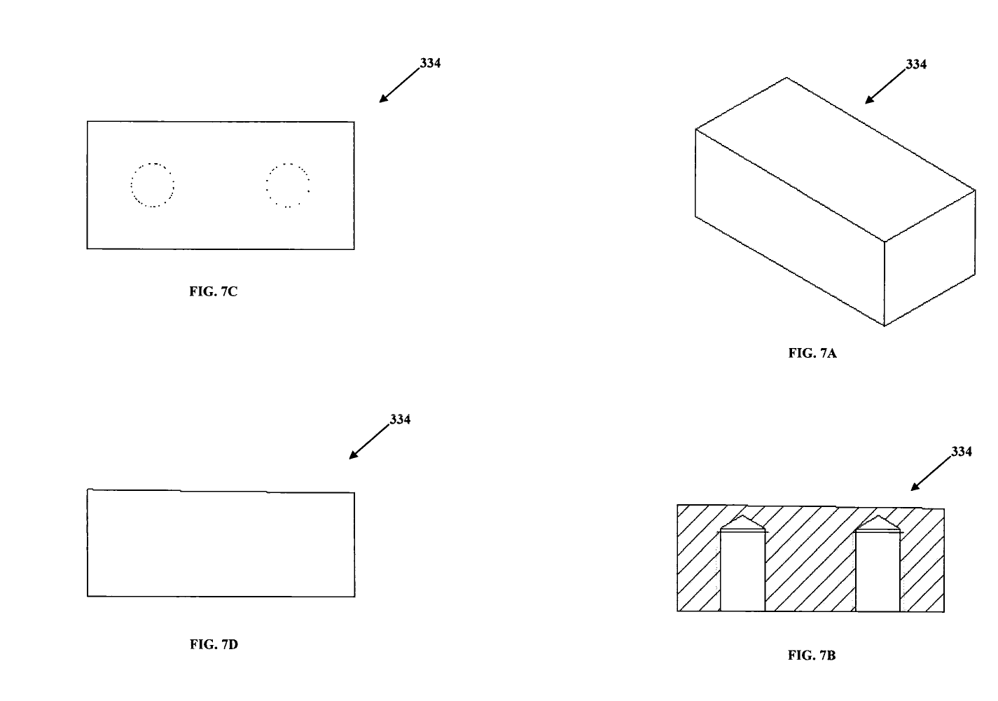

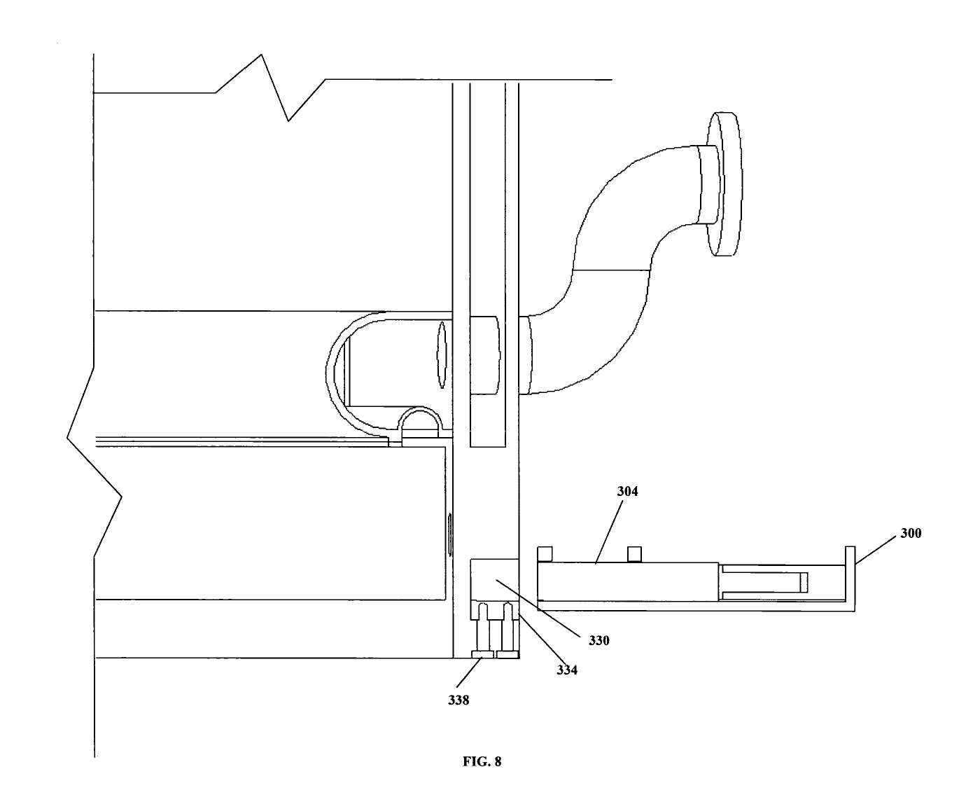

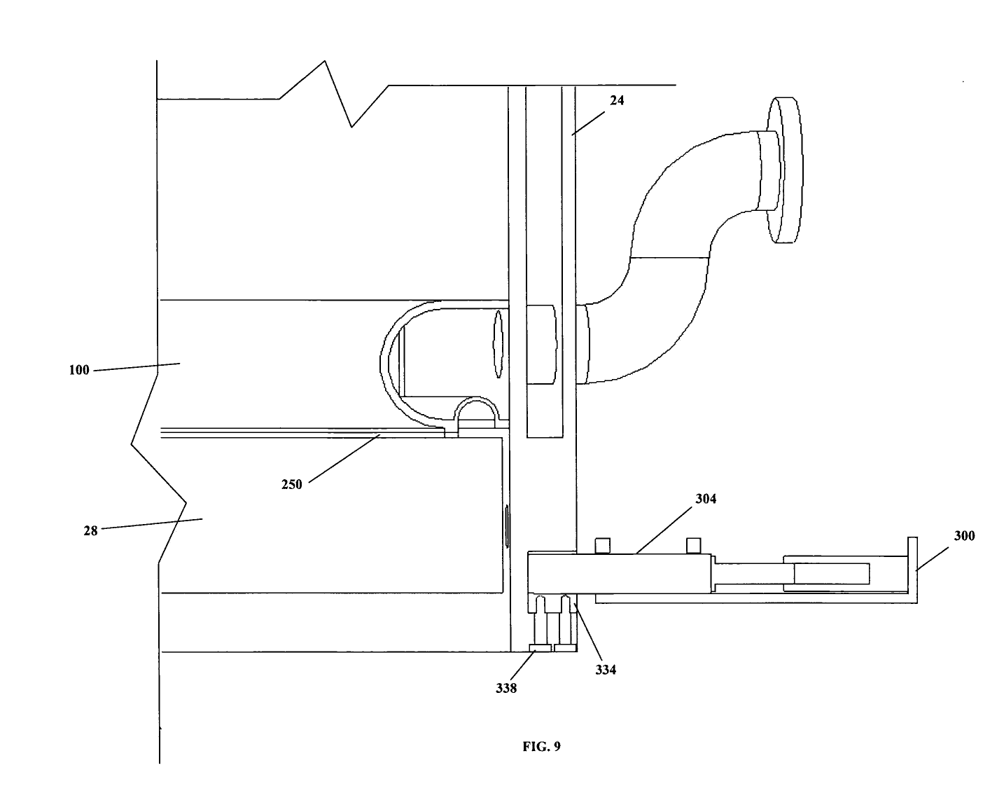

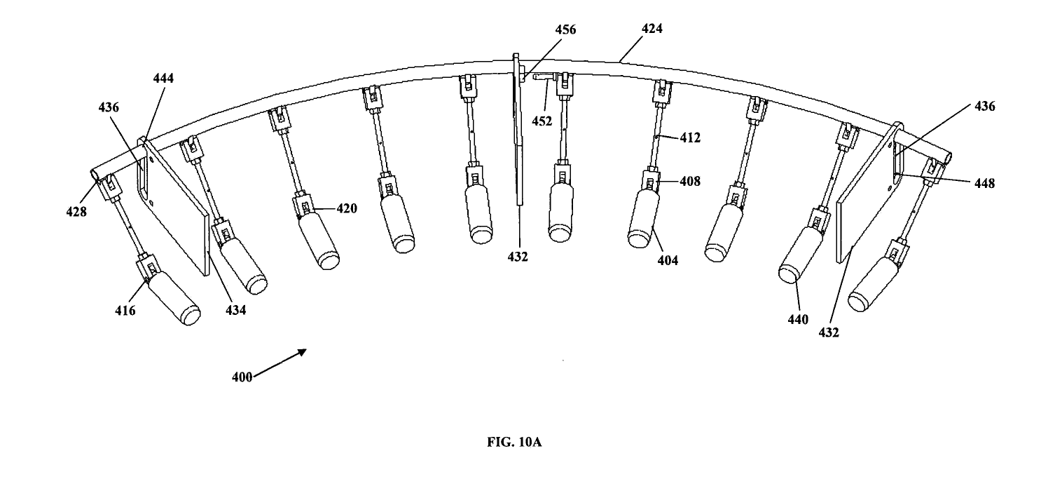

A gasket 250 on the base plate 28 is configured to be seated beneath the sealing tongue 112 of the sealing device 100 when the vessel 20 is closed. In the case of a vertical vessel, such as the vessel 20, the weight of the vessel typically provides at least a portion of the force for seating the gasket 250. Additional force appropriate to fully seat the gasket 250 may be provided by a seating mechanism, e.g., a plurality of seating wedges 300, one of which is shown in FIGS. 5A and 5B. The seating wedges 300 may be spaced around the exterior of the vessel shell 24. A seating wedge 300 includes a wedge 304 and an actuator 308 mounted on an anchor plate 312. The actuator 308 has a piston 316 for driving the wedge 304 through a wedge guide 320 and into a corresponding slot 330, shown in FIG. 6, in the exterior of the shell 24. The wedge 304 is driven over a wedge-shaped insert 334 in the slot 330. A wedge-shaped insert 334 is shown in greater detail in FIGS. 7A-7D. As shown in FIG. 8, the wedge-shaped insert 334 is attached in the slot 330, e.g., by bolts 338. A wedge 304 is shown in FIG. 8 in a retracted position and in FIG. 9 in an engaged position.

As wedges 304 are pushed over the wedge-shaped inserts 334, they cause the shell 24 to be pulled tighter against the base plate 28, thus providing additional force to seat the gasket 250. In the present example embodiment, the actuators 308 are linear double actuators that may be, e.g., hydraulic, pneumatic and/or electric, etc. It should be noted, however, that other or additional methods of seating the gasket 250 may be used. For example, rotational actuators such as cams may be used; linear actuators may be aligned with a vessel to push and/or pull along an axial direction of the vessel rather than transversely as previously described; solenoid(s) may be used to employ magnetic force; etc. It should be understood generally that seating mechanisms could have various types, sizes, profiles, shapes, and/or locations in various vessel configurations in accordance with aspects of the present disclosure.

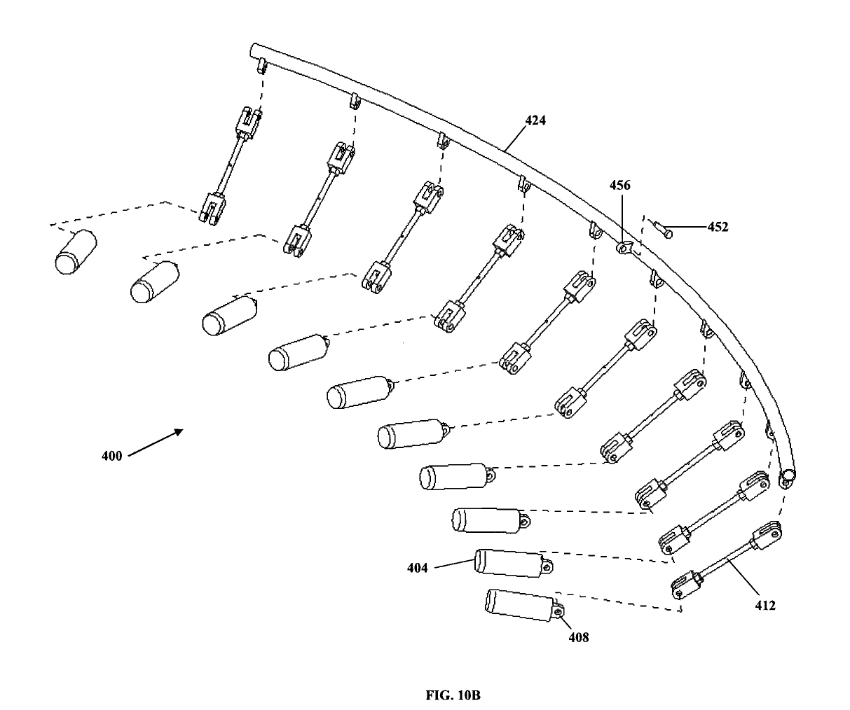

Once the shell 24 is fully lowered by activation of the seating wedges 300, one or more locking assemblies 400 may be used to lock the shell 24 in place. An example locking assembly 400 is shown in FIGS. 10A and 10B. A plurality of pins 404 are configured for engagement through the shell 24 and into holes 32 in the base plate 28. The grouping of locking pins 404 into one or more locking assemblies 400 can promote operating speed, convenience, and safety. It should be noted, however, that locking pins could be arranged in other or additional ways to lock a vessel shell in place.

In the example shown in FIGS. 10A and 10B, each locking pin 404 has a clip 408 for connection with a connecting link 412 via a pin 416 to allow planar rotation about a joint 420. The connecting link 412 is attached to a locking rod 424 via a pin 428 to allow substantially the same planar rotation. The locking rod 424 is supported at two or more locations (in the present example, three locations) by supports 432 each having an edge 434 configured for rigid attachment to the exterior of the shell 24. The motion of the locking rod 424 is guided and restricted by guide slots 436 in the supports 432. Each of the locking pins 404 has a tapered end 440. When the locking rod 424 is lifted to the top 444 of the guide slot 436, the locking pins 404 are in a fully retracted position relative to the shell 24 and base plate 28. When the locking rod 424 is lowered to the bottom 448 of the guide slot 436, the locking pins 404 are fully engaged in the shell 24 and base plate 28. A locking rod 424 can be locked in each of these two positions by means of a safety pin 452 that may be pushed through a tab 456 on the locking rod 424 and a centrally located support 432. The safety pin 452 acts substantially as a fail-safe measure to prevent the locking pins 404 from being retracted during operation of the vessel 20.

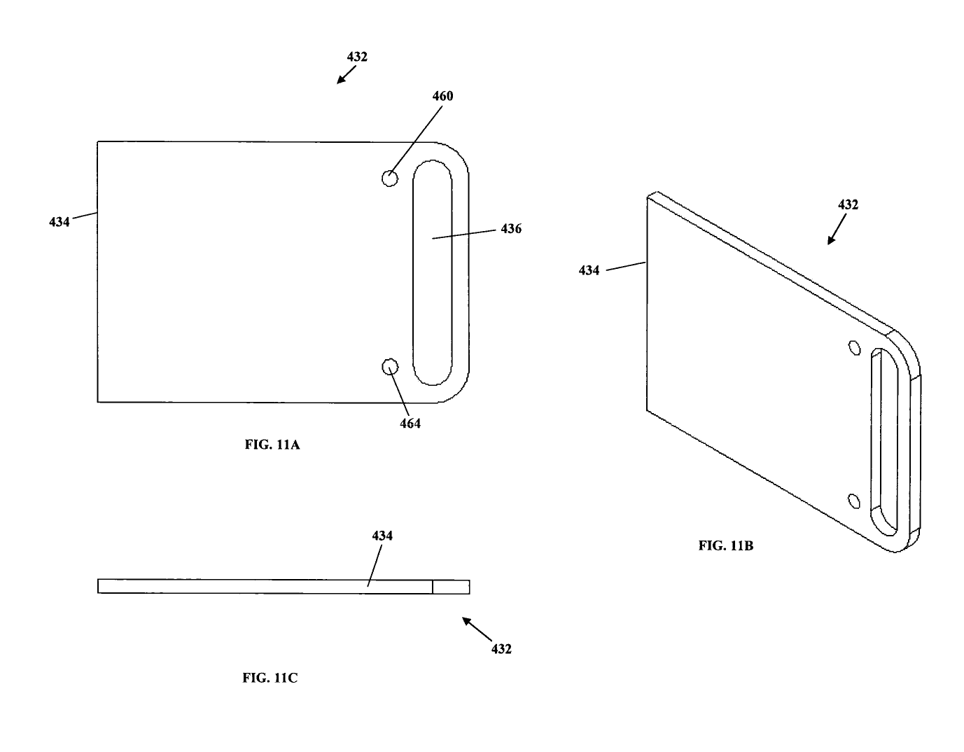

One configuration of a support 432 is shown in FIGS. 11A-11C. A first hole, e.g., an upper hole 460, may receive the safety pin 452 through the tab 456 to retain the locking rod 424 in an unlocked position. A second hole, e.g., a lower hole 464, may receive the safety pin 452 through the tab 456 to retain the locking rod 424 in a locked position.

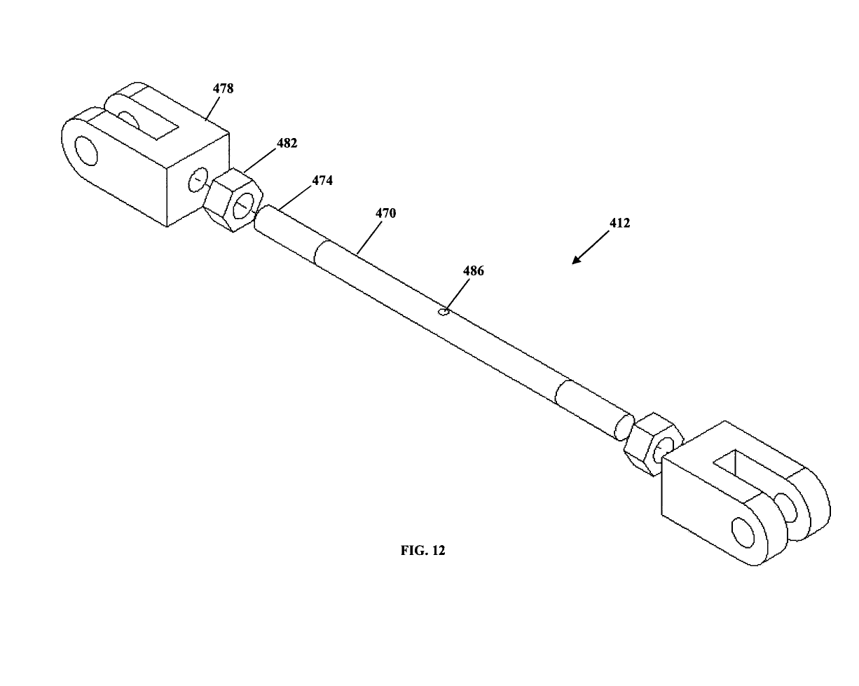

An example connecting link 412 is shown in FIG. 12. The connecting link 412 has a rod 470 connected at ends 474 between two clips 478 and secured by nuts 482. In order to minimize stress levels and wear on the locking pins 404 and holes (32, 44) in the shell 24 and base plate 28, appropriately tight tolerances are provided between the size of the locking pins 404 and the holes (32, 44). In order to prevent alignment issues that might otherwise be presented by tight tolerances during fabrication and installation, the connecting links 412 are adjustable in length and the ends 440 of the locking pins 404 are tapered to facilitate the initiation of engagement of the locking pins 404 in the base plate holes 32. Opposite threads (not shown) on the ends 474 of the rod 470 make it possible to adjust the length of the connecting link 412 by turning the rod 470 (similar to a turnbuckle). A turnkey hole 486 may be provided for making such adjustments. Once the length of a connecting link 412 is adjusted appropriately, the length can be fixed by tightening the nuts 482 against the clips 478. Carbon steel is one example material from which supports, locking rods, and locking pins may be made, although other or additional suitable materials may be used.

One embodiment of a method of closing and locking a vessel is described below. It should be understood, however, that other or additional method embodiments may be used. For example, a locking mechanism in accordance with aspects of the disclosure could be manual, automated, pneumatic, hydraulic, electric, etc. and may be attached to a vessel container component and/or surrounding support structure. It should be understood generally that locking mechanisms could have various types, sizes, profiles, shapes, and/or locations in various vessel configurations in accordance with aspects of the present disclosure. It should also be understood that a gasket could be seated and a vessel could be locked by means of a single mechanism, e.g., in which cams or other actuators are used to move the vessel relative to the gasket and to secure the vessel container components together. Further, in some configurations it is possible for seating and locking to be performed substantially simultaneously.

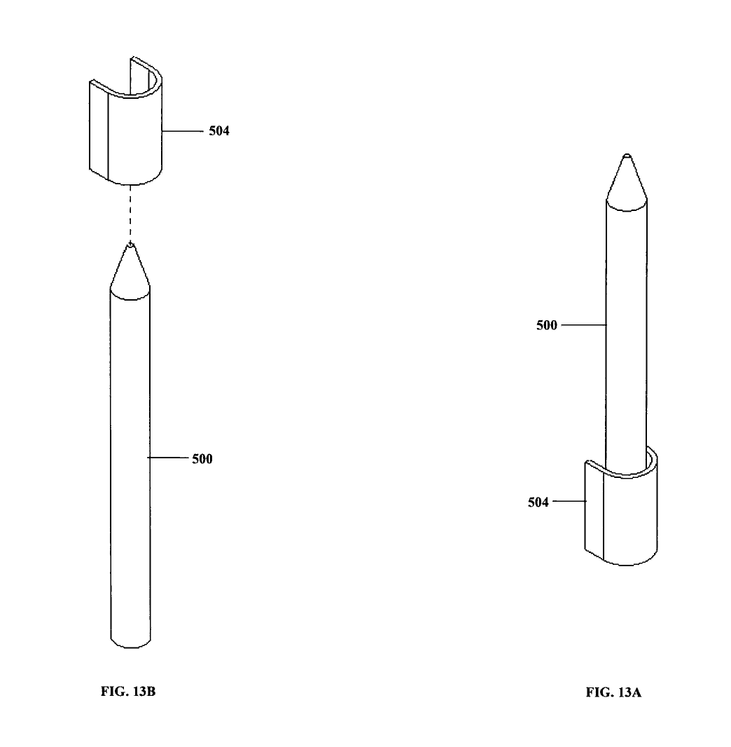

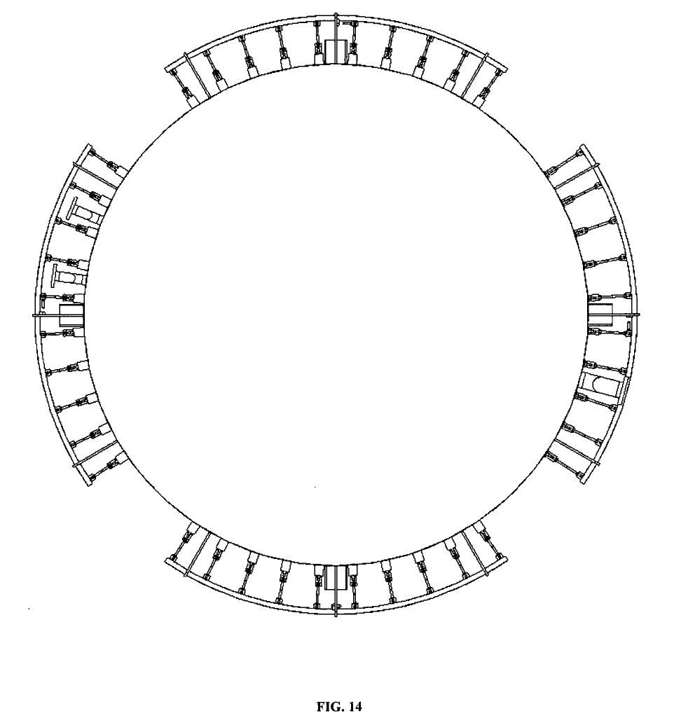

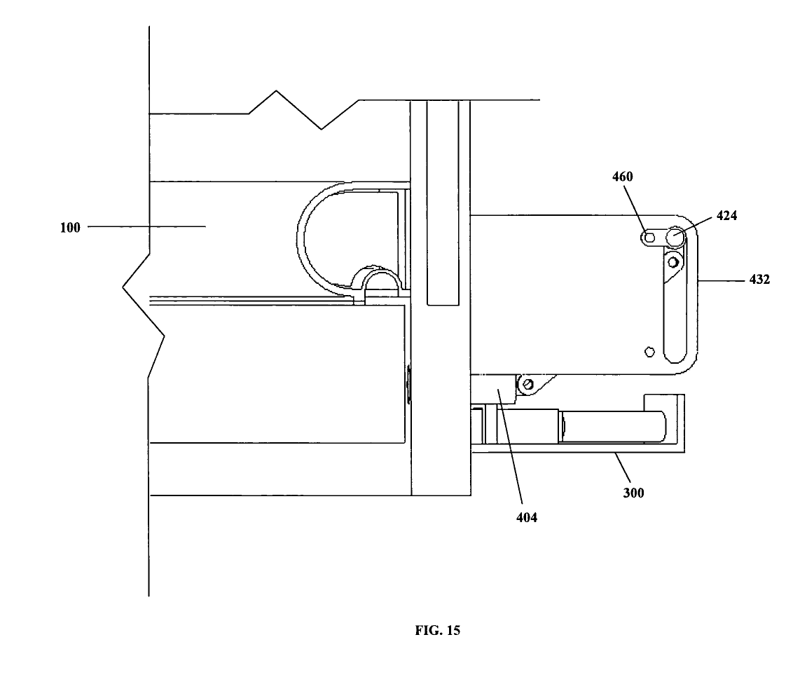

One method of closing a vessel shall now be described with reference to the vessel 20. To close the vessel 20, the shell 24 may first be generally aligned, then finely aligned, with the base plate 28. A plurality of alignment rods 500, e.g., as shown in FIGS. 13A and 13B, may be used to establish general alignment of the shell 24 as it is lowered toward the base plate 28 and to initiate engagement of the wedge portions 204 with bases 212 of the alignment wedges 200. Alignment rod guides 504 attached to the shell 24 are placed over alignment rods 500 attached to the base plate 28 and/or support structure 228. The rods 500 may or may not be of varying lengths and may be spaced apart, e.g., about ninety degrees apart, around the base plate 28. As the shell 24 reaches its lowered position, the alignment wedges 200 come into engagement to provide fine alignment of the shell 24 with the base plate 28 such that the locking pins 404 may be aligned with their respective holes 44 and 32.

After the shell 24 has been finely aligned with the base plate 28, the seating wedges 300 may be used to seat the gasket 250 against the sealing device 100. It should be noted that the seating wedges 300 used to seat the gasket 250 need only be capable of producing a force similar to a load adequate to seat the gasket 250 rather than a force similar to a full pressure end load in the vessel 20. The smaller force is adequate because the sealing device 100 is flexible and because the locking pins 404, independent of the sealing device 100, are used to lock the shell 24 to the base plate 28.

After the gasket 250 has been seated, the shell 24 may be locked to the base plate 28 by one or more locking assemblies 400. In the present example, four locking assemblies 400 are used. A top view of the shell 24 and the locking assemblies 400 is shown in FIG. 14. As the shell 24 is lowered, the locking pins 404 of each locking assembly 400 are held in retracted positions by means of the safety pin 452 fixing the locking rod 424 at the top of the guide slot 436. As shown in FIG. 15, the shell 24 is in a lowered position over the base plate 28 with the locking pins 404 still held in retracted positions by the safety pin 452. The seating wedges 300 are still engaged.

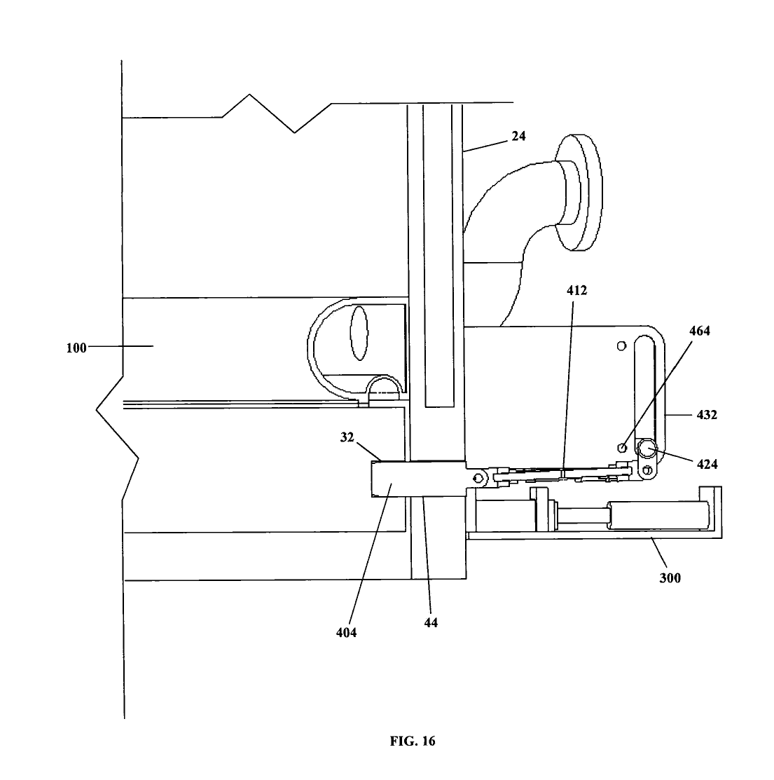

Once the shell 24 is fully lowered by the seating wedges 300, the safety pin 452 may be removed from the upper hole 460 of the support 432 and the locking rod 424 may be pushed down to the bottoms 448 of the guide slots 436, forcing the locking pins 404 into their respective holes 32 in the base plate 28. When a locking rod 424 reaches the bottom 448 of the guide slot 436 as shown in FIG. 16, the locking pins 404 on the rod are fully engaged in the holes 44 and 32. When the locking pins 404 are fully engaged, the safety pin 452 may be placed through the tab 456 on the locking rod 424 and its support 432 for each locking assembly 400. When the locking rods 424 are all secured in the engaged position by the safety pins 452, the seating wedges 300 are retracted, e.g., so that an entire pressure end load in the closed vessel 20 may be taken by the locking pins 404.

Once the vessel 20 is completely shut down and safe for disassembly, the vessel 20 may be disassembled as follows. The shell 24 first is returned to its original gasket seating state such that there is no friction load on the locking pins 404. To do this, the seating wedges 300 are engaged to lower the shell 24. The safety pins 452 are then removed and the locking rods 424 are secured at the top of the guide slot 436 to hold the locking pins 404 in their retracted position. The seating wedges 300 are then disengaged and the shell 24 can be lifted away from the base plate 28.

In one embodiment of a method in accordance with the present disclosure, the following steps may be taken to close a vessel having first and second container components. The first container component is lowered onto the second container component. A gasket of the second component is seated against a flexible sealing device in the first container component. Locking pins may then be engaged through the first container component and into the second container component, e.g., by lowering and securing locking rods attached to the first container component and on which the locking pins are pivotally attached. The following steps may be taken to disassemble the vessel after use. The first container component is reseated onto the second container component. The locking pins are removed from the container components, e.g., by raising and securing the locking rods. The first container component then may be removed from the second container component.

The foregoing closure can be used on small and large diameter vessels and can be used for low and high pressure and temperature applications. Configurations of the closure can be used in relation to vessels that have high temperature gradients in mobile and fixed components. The foregoing closure can facilitate fast operation of processes and can provide a high degree of safety. A relatively low initial tightening force is sufficient, and no bolting is required. Internal pressure acting on top of the sealing device 100 provides an additional “self-sealing” force.

The flexibility of the sealing device 100 allows the closure to be used for low and high pressure and temperature applications, while also reducing the initial tightening force. It should be noted that the closure can be inherently safe. When a vessel is pressurized, the pressure end load provides a shear force on the locking pins. There would be essentially no force acting to retract the locking pins. To the contrary, a large friction force developed between the locking pins and their holes tends to hold the locking pins in their engaged position.

The sealing device 100 is appropriately strong and durable yet flexible enough to eliminate a need for a high initial tightening force and to compensate for temperature differences between the shell 24 and base plate 28. Because of the flexibility, the sealing device can initially be “spring loaded.” Also due to the design of the sealing device, internal pressure in the vessel when in use pushes the sealing device 100 against the gasket 250, therefore providing an additional “self-sealing” force.

The flexibility of the sealing device 100 compensates for differential movements between the shell 24 and base plate 28 due to mechanical and thermal growth. This compensation can keep the integrity of the vessel's seal, and therefore safety, from being compromised due to high pressure and/or a high temperature gradient between the shell and base plate. This makes the present closure compatible with low and high pressure and temperature (including high temperature gradient) applications.

Because the sealing device and locking assemblies are independent of each other, the sealing device is not required to compensate for the entire pressure end load because this force is taken solely by the locking assemblies. This, along with the flexibility of the sealing device, means that the initial clamping force for providing a seal during operation of the vessel is very low relative to other designs. Therefore, the present closure is compatible with both small and large diameter vessels.

Because of the design of the sealing device, the force pushing down on the device due to pressure during operation is greater than the force pushing up on the device. The additional force pushing down acts to further seal the vessel to the base plate. This makes the closure very advantageous for high pressure applications, since the greater the internal pressure, the greater the additional sealing force will be.

The “closed-loop” and baffled design of the sealing device allows for simple application of a cooling fluid that can be used to maintain a desired temperature of the sealing device. This makes the closure very advantageous for high temperature and high temperature gradient applications without the addition of any complex piping system(s). The pressure and temperature of the cooling fluid can be used to control the uniformity of the contact between sealing surfaces. Therefore, an optimal cooling fluid pressure and temperature can be built into a design for a sealing device cooling system. This pressure and temperature can be variable (if necessary) during a start-up or shut-down cycle.

The locking assembly design is very simple and substantially fail-proof. The grouping of locking pins in locking assemblies makes for faster and easier operation. The design predetermines the loading that the locking pins will be required to take (shear load only), making the design calculations for the pins very simple and predictable. A locking assembly can have few moving parts, all of which are completely mechanical and manual, making it very fast and easy to operate and maintain. Implementations also are possible in which operation of a locking assembly is automated. The use of a mechanical safety pin to ensure that the locking assembly cannot be disengaged during operation makes the closure a very safe configuration.

Where appropriate tolerances have been provided during fabrication and installation, the locking pins 404 may slide into the holes 44 and 32 with little or no resistance. Therefore, a locking rod 424 can be operated manually with speed and ease, eliminating the need for a power-actuating mechanism. Nevertheless, automation, power actuation, etc., could be provided where desired.

The locking assembly design is inherently very safe. This is because the pressure end load (force) of the vessel during operation causes a large shear load on the locking pins, while there is no load acting to retract (disengage) the pins. The shear load creates a very large friction force between the locking pins and the base plate, making it very difficult (if not impossible) to retract the pins during operation. Therefore, it is virtually impossible for the locking assembly to be accidentally disengaged during operation.

The seating wedges are designed such that a horizontal movement of the wedge creates a vertical movement of the vessel shell, therefore “clamping” the shell to the base plate. Once the locking pins are engaged, the seating wedges are retracted. This means that the seating wedges do not need to be designed to withstand the pressure end load (force). Therefore, the size of the seating wedges and actuators can remain relatively small.

The alignment wedges are used to provide the fine alignment required to allow for appropriately tight tolerances between the locking pins and their respective holes in the base plate. Where the engaging parts of the wedges are round in shape, the alignment wedges can provide alignment in all directions.

The present closure can be adapted to work in relation to many vessel designs. As the closure is compliant with both low and high pressure and temperature conditions, it is suitable for a wide variety of industries. Implementations are possible in relation to vessels oriented horizontally and/or in other directions. Accordingly, a first container component of a vessel may be positioned “over” a second container component of the vessel in accordance with various implementations, even where, e.g., the first container component is underneath or alongside the second container component.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of the example embodiments.

Spatially relative terms, such as “inner,” “outer,” “over,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of closing a vessel, the method comprising:
using a flexible sealing device, forming a seal between two container components of the vessel; and
locking together the two container components using a locking mechanism capable of bearing an end pressure load against the vessel when the vessel is in operation;
the method performed so that the sealing device bears substantially none of the end pressure load when the vessel is in operation.

2. The method of claim 1, wherein forming a seal comprises seating a gasket in the vessel using the flexible sealing device.

3. The method of claim 2, wherein the seating is performed by a seating mechanism or the locking mechanism.

4. The method of claim 1, further comprising controlling a jacket fluid in the sealing device when the vessel is closed;
the controlling performed to vary one or more of the following: a temperature of the sealing device, a contact pressure of the sealing device, and a contact width of the sealing device.

5. The method of claim 4, further comprising adjusting the pressure and/or temperature when the vessel is in operation;
the adjusting performed as a predetermined adjustment or based on feedback from the vessel.

6. A closure for closing a vessel, the vessel having first and second container components, the closure comprising:
a flexible sealing device for attachment to one of the first and second container components such that the sealing device covers an edge of the other of the first and second container components inside the vessel when the vessel is closed; and
a locking mechanism configured to secure the first container component to the second container component when the first container component is closed over the second container component;
the locking mechanism, but substantially not the sealing device, configured to bear a pressure end load against the vessel when the vessel is in use.

7. The closure of claim 6, where the pressure load within the vessel contributes to a sealing force of the flexible sealing device.

8. The closure of claim 6, the locking mechanism comprising one or more locking assemblies each having a plurality of locking members, the locking members having pins for insertion though holes in the first container component into bores of the second container component to close the vessel, the pins configured to bear the end pressure load.

9. The closure of claim 6, further comprising a seating mechanism having a plurality of actuators operable to move the first container component relative to the second container component;
whereby a gasket is seated inside the vessel against the flexible sealing device.

10. The closure of claim 9, wherein the actuators are retractable from the vessel after engagement of the locking mechanism.

11. The closure of claim 6, further comprising a plurality of alignment wedges each having a wedge portion attachable to one of the first and second container components or to support structure, and a base portion attachable to the other of the first and second container components or to support structure, the wedge portion rotatable in the base portion.

12. A vessel comprising the closure of claim 6.

13. A sealing device for use in sealing a vessel, the sealing device comprising:
a flexible, substantially closed-loop channel configured to be sealed against a first container component of the vessel when the vessel is closed;
the channel configured to provide a jacket for fluid when the sealing device is attached to a second container component of the vessel.

14. The sealing device of claim 13, the channel further comprising first and second portions configured for attachment to the second container component to provide the jacket.

15. The sealing device of claim 13, further comprising one or more baffles in the channel, each baffle having an end plate extending between and attached to first and second portions of the channel.

16. The sealing device of claim 13, wherein a fluid in the jacket when the vessel is closed may be controlled to vary one or more of the following: a temperature of the sealing device, a contact pressure of the sealing device, and a contact width of the sealing device.

17. The sealing device of claim 16, wherein temperature and/or pressure of the fluid may be adjusted when the vessel is in operation.

18. The sealing device of claim 17, wherein an adjustment is made as a predetermined adjustment or based on feedback from vessel operation.

19. The sealing device of claim 13, configured to be sealed against a gasket of the first container component.

20. A vessel comprising the sealing device of claim 13.
